(19) United States
(12) Patent Application Publication
(10) Pub. No.: US 2010/0087560 A1
(43) Pub. Date: Apr. 8, 2010

(54) POLYISOCYANURATE FOAM FOR ROOF STRUCTURES

(76) Inventors: Steven P. Crain, Midland, MI (US); Michael J. Skowronski, Marietta, GA (US)

Correspondence Address: The Dow Chemical Company, Intellectual Property Section, P.O. Box 1967, Midland, MI, 48641-1967, US

(21) Appl. No.: 12/597,521

(22) PCT Filed: Apr. 24, 2008
(86) PCT No.: PCT/US08/61361

§ 371 Date: Oct. 26, 2009

Related U.S. Application Data
(60) Provisional application No. 60/930,625, filed on May 17, 2007.

(51) Int. Cl. C08J 9/00

(52) U.S. Cl. 521/155

(57) ABSTRACT

Prepare a polyisocyanurate insulating foam that achieves a Class A rating in ASTM E108-05 testing with either EPDM or TPO membranes at a slope of 1.27 centimeters and achieves at least a grade 2 designation in ASTM method C-1289 compressive strength testing with a foamable mixture containing (a) 100 parts by weight polyol; (b) 2-9 parts by weight potassium and/or sodium carboxylate salts; (c) 0.05-0.45 parts by weight of one or more quaternary amine; (d) zero to 0.4 parts by weight of an additional catalyst selected from secondary amine, tertiary amine, tin and/or iron catalyst; (e) optionally a solvent; (f) an isocyanate containing compound; and (g) a blowing agent; wherein the molar ratio of (b) to (c) is in a range of 17:1 to 100:1.

### CROSS REFERENCE STATEMENT

This application claims benefit of U.S. Provisional Application Ser. No. 60/930,625 filed on May 17, 2007.

### BACKGROUND OF THE INVENTION

1. Field of the Invention

The present invention relates to a foamable mixture and a method of using the foamable mixture for preparing polyisocyanurate foam.

2. Description of Related Art

A typical membrane roof structure comprises layers of components including a support structure layer, an insulating foam layer and a membrane layer. Common support structures include oriented strandboard (OSB) or plywood decking on wood or metal support framework. Insulating foams can be a thermoplastic polymer foam, such as foamed polystyrene, or a thermoset polymer foam, such as polyisocyanurate. Membranes extend across the membrane roof structure and typically attach to the support structure using one or more means including adhesives such as glue, mechanical fasteners such as screws or nails, and ballast material. Membranes are typically an elastic material such as a thermoplastic polyolefin (TPO), polyvinylchloride (PVC) or a polymer of ethylene-propylene-diene monomer (EPDM).

Membrane roof structures must meet certain fire retardancy testing codes in order to be commercially acceptable. Exemplary testing codes include Underwriters Laboratories (UL) 790 and 263 codes, Factory Mutual (FM) 4450 code and American Society for Testing and Materials (ASTM) method E-108 and E-84 tests. Passing these code requirements can be challenging, particularly for roof structures comprising a membrane such as EPDM or TPO that is not modified to enhance flame retardancy. EPDM and TPO membranes are less inherently flame retardant than other membranes such as PVC membranes.

Polyisocyanurate foam insulation is particularly desirable for use in membrane roof structures due to their inherent dimensional stability despite broad temperature fluctuations.

Besides having dimensional stability over broad temperature ranges, the insulating foam for use in membrane roofing applications also must have a certain compressive strength in order to remain mechanically sound in roofing applications. In particular, it is desirable for an insulating foam to achieve at least a grade 2 designation in ASTM method C-1289 compressive strength testing for it to be desirable for use in a membrane roofing application.

It is desirable to identify a method for preparing polyisocyanurate foam compositions that achieve a Class A rating in ASTM E108-05 (which is the same as UL790) testing with either EPDM or TPO membranes at a slope of 1.27 centimeters (0.5 inches), that is a 1.27 cm rise over a 30.48 centimeter run (herein “slope” refers to the rise over a 30.48 centimeter run unless indicated otherwise). It is further desirable if the method prepares a foam that achieves at least a grade 2 designation in ASTM method C-1289 compressive strength testing. Such an insulating foam would be suitable for a wide range of membrane roofing applications in combination with a wide range of membranes due to the foam's exceptional flame retardant properties.

### BRIEF SUMMARY OF THE INVENTION

The present invention provides a method for preparing polyisocyanurate insulating foam that is suitably flame retardant and structurally sound to simultaneously achieve a Class A rating in ASTM E108-05 (which is the same as UL790) testing with either EPDM or TPO membranes at a slope of 1.27 centimeters and achieves at least a grade 2 designation in ASTM method C-1289 compressive strength testing. Surprisingly, desirable flame retardant and compressive strength properties were achieved by use of a specific catalyst composition in a foamable mixture used to prepare the polyisocyanurate insulating foam. Such a polyisocyanurate insulating foam is suitable for a wide range of membrane roofing applications in combination with a wide range of membranes due to the foam's exceptional flame retardant properties.

In a first aspect, the present invention is a foamable mixture comprising: (a) 100 parts by weight of one or more polyol; (b) 2 to 9 parts by weight of one or more salt selected from potassium carboxylate and sodium carboxylate salts; (c) 0.05 to 0.45 parts by weight of one or more quaternary amine; (d) zero to 0.4 parts by weight of one or more catalyst compound selected from a group consisting of secondary amines, tertiary amines, tin catalysts and iron catalysts; (e) optionally, a solvent; (f) an isocyanate-containing compound; and (g) a blowing agent; wherein, the molar ratio of (b) to (c) is in a range of 17:1 and 100:1.

Desirable embodiments of the first aspect include one or a combination of more than one of the following further characteristics: (c) is one or more alkyl carboxylate quaternary amine; component (b) comprises one or more potassium carboxylate; (b) is present at 2.4-7 weight parts; (c) is present at 0.13 to 0.4 weight parts; and (d) is present at 0.12 to 0.4 weight parts; component (b) is one or more potassium carboxylate, component (c) is one or more alkyl carboxylate quaternary amine, component (d) is one or more tertiary amine and is present at a concentration of 0.12 to 0.4 weight parts; the polyol is a polyester polyol; the amount of isocyanate containing compound(s) and polyester polyol is such that the mixture has an isocyanate index in a range of 200-600; the blowing agent is halogen-free; and further comprising water at a concentration of 0.2 to 3 weight parts.

In a second aspect, the present invention is a method for preparing a laminated polyisocyanurate foam comprising: (i) disposing the foamable mixture of the first aspect onto a first facing sheet; and (ii) allowing the foamable composition to expand into a polyisocyanurate foam.

Desirable embodiments of the second aspect include one or a combination of more than one of the following further characteristics: the foamable mixture is continuously disposed onto the first facing sheet while the facing sheet is being conveyed; further comprising disposing a second facing sheet onto the foamable mixture such that the foamable mixture is between the two facing sheets; the amount of isocyanate containing compound(s) and polyol is such that the mixture has an isocyanate index in a range of 200-600; the foamable mixture further comprises water at a concentration of 0.2 to three percent by weight based on component total weight of polyol in the mixture; and component (b) is one or more potassium carboxylate component, (c) is an alkyl carboxylate quaternary amine, component (d) is one or more tertiary amine and is present at a concentration in a range of 0.12 to 0.4 weight parts.

### DETAILED DESCRIPTION OF THE INVENTION

### Terms

“Hydroxy functionality” refers to an —OH group on a molecule. For example, methanol has a singly hydroxy functionality per molecule.

“Isocyanate” a reactive chemical grouping composed of a nitrogen atom bonded to a carbon atom bonded to an oxygen atom (that is, —N═C═O). “Isocyanate” also refers to a chemical compound containing one or more isocyanate groups (functionalities).

“Isocyanate index” is a measure of a stoichiometric balance between equivalents of isocyanate functionalities and hydroxy functionalities in a mixture of reactants. Isocyanate index is 100 times the number of isocyanate functionalities divided by the number of hydroxy functionalities.

“Isocyanurate” refers to a cyclic trimer formed by a reaction between three isocyanate groups.

“Slope” refers to a rise over a 30.48 centimeter (12 inch) run. A slope of 1.27 centimeters refers to a feature such as a roof that has a 1.27 rise over a 30.48 centimeter run.

Unless indicated otherwise, ranges herein include endpoints.

### Catalyst Composition

The present invention includes a catalyst composition that surprisingly is useful for preparing polyisocyanurate foam that is particularly flame retardant. Catalysts are useful in preparing polyisocyanurate foam by facilitating a reaction between isocyanate-containing molecules to form isocyanurates. The nature and proportion of catalyst plays a critical role in the preparation of polyisocyanurate foam (see, for example, GB1489819, page 1, lines 33-35; incorporated herein by reference). Surprisingly, the particular catalyst composition of the present invention not only plays a critical role in preparing polyisocyanurate foam but in preparing a such a foam that is particularly flame retardant and that has a desirable compressive strength.

A typical reaction mixture for preparing polyisocyanurate foam contains isocyanate-containing compounds, a polyol and a catalyst. The reaction mixture will have an isocyanate index greater than 100, meaning there are more isocyanate functionalities present in the mixture than hydroxy functionalities. As the isocyanate index of a reaction mixture increases, so does the likelihood of isocyanurate formation and, hence, polyisocyanurate formation. Isocyanurate formation generally occurs at a slower rate than reaction of an isocyanate with a hydroxy functionality. Catalysts are useful to facilitate isocyanate reaction with other isocyanates to form polyisocyanurates. Nonetheless, it is not uncommon for residual isocyanate-containing compounds to remain unreacted. Unreacted isocyanate-containing compounds are undesirable because they tend to decrease the resulting polymer flame retardancy. It is believed that the present invention ensures extensive, if not complete, reaction of isocyanate-containing monomers. That, in itself, enhances the flame retardant properties of a resulting polymer. Surprisingly, polymer foams prepared using a hydrocarbon blowing agent and with the present catalyst composition can achieve a Class A rating in ASTM E108-05 (UL790) testing and at the same time a grade 2 or better designation under ASTM method C1289 compressive strength testing when similar foams prepared from a different catalyst composition cannot.

The catalyst composition of the present invention comprises the following components: (i) a salt selected from potassium carboxylate and sodium carboxylate salts; (ii) a quaternary amine; (iii) optionally, one or more catalyst compound selected from a group consisting of tertiary amines, tin catalysts and iron catalysts; and (iv) optionally, a solvent. Other catalyst may be present in the catalyst composition besides components (i)-(iv). However, the catalyst composition desirably consists of components selected from components (i)-(iv) at concentrations described herein so that the combined weight of components (i)-(iv) is 100 wt % of the catalyst composition weight.

The salt component is one or more potassium carboxylate, one or more sodium carboxylate or a combination of one or more potassium carboxylate and one or more sodium carboxylate. The salt component facilitates isocyanurate formation. In one preferred embodiment the salt component is one or more potassium carboxylate. The carboxylate can be any carboxylate or combination of carboxylates. For example, one desirable salt component is a combination of potassium octoate and potassium acetate. Other suitable salt components include potassium or sodium carboxylate salts having from one to eight carbons such as the salts of formic, acetic, propionic and 2-ethylhexanoic acids.

The quaternary amine component, without being bound by theory, is believed to serve a critical role as a latent catalyst that facilitates reaction of residual isocyanates towards the end of a polymerization reaction. The quaternary amine component (that is, “quat”) can be any quat, but is desirably an alkyl carboxylate quaternary amine. Particularly preferred quats include those made from lower-alkanoic acid containing from 1 to 8 carbon atoms including formic, acetic, propionic, butyric, pentanoic, hexanoic, heptanoic, octanoic, and isomers thereof. The quats desirably contain substituents selected from a group consisting of lower alkyl, substituted-lower-alkyl (for example, hydroxy- or halo-lower-alkyl), and aralkyl. Suitable quaternary amine components are and their preparation are described in U.S. Pat. No. 3,954,684, which is incorporated herein by reference.

Component (iii) of the catalyst composition is optional and is one or more catalyst compound selected from a group consisting of secondary amines, tertiary amines, tin catalyst and iron catalysts. Component (iii) is believed to facilitate a reaction between isocyanate functionalities and hydroxy functionalities to exothermically form polyurethane, thereby facilitating creaming of a reaction mixture. Component (iii) is desirably a tertiary amine, such as because tertiary amines have a longer catalytic life than lower amines. Component (iii) is desirably a tertiary amine because tertiary amines have a longer catalytic lifetime than lower amines.

Component (iv) is also optional and is a solvent for use in facilitating handling of the catalyst composition, introduction of the catalyst composition when preparing a reactive mixture and to facilitate dispersion of the catalyst components within a reactive mixture. Suitable solvents include dibasic esters, ethylene carbonate, polygylcols, triethyl phosphate and dimethylformamide. The solvent is typically present at a concentration of up to 60 wt %, based on a combined weight of components (i)-(iv). Desirably, solvent is present at a concentration of 20-60 wt %, based on a combined weight of components (i)-(iv). At a solvent concentration greater than 60 wt %, based on a combined weight of components (i)-(iv), the solvent begins to cause dimensional stability issues with the polymer foam.

### Foamable Mixture

One aspect of the present invention is a foamable mixture suitable for forming a polyisocyanurate foam that can achieve a Class A rating in ASTM E-108-05 testing with either EPDM or TPO membranes at a slope of 1.27 centimeters (cm) and a grade 2 designation in ASTM method C-1289 compressive strength testing.

The foamable mixture comprises one or more polyol, an isocyanate containing compound, the catalyst composition discussed above and a blowing agent. In particular, the foamable composition comprises: (a) one or more polyol; (b) one or more salt selected from potassium carboxylate and sodium carboxylate salts; (c) one or more quaternary amine (quat); (d) one or more catalyst compound selected from a group consisting of secondary amines, tertiary amines, tin catalysts and iron catalysts; (e) optionally a solvent; (f) an isocyanate containing compound; and (g) a blowing agent. The foamable mixture can also include one or more component selected from a group consisting of blowing agents, surfactants, flame retardants, fillers, viscosity reducers, heat stabilizers and ultraviolet (UV) stabilizers to form a mixture.

Components (b)-(e) correspond to components (i)-(iv) of the catalyst composition, described above. Hence, the foamable mixture contains the catalyst composition previously described.

The salt component (b) is present at a concentration of 2 to 9 parts, preferably 2.4 to 7 parts by weight per 100 parts by weight polyol (part per hundred polyol, or “pphp”). When the salt component is present at a concentration below 2 pphp the foamable mixture undergoes incomplete trimerization, resulting in a foam having poor flame retardant properties and low dimensional stability. When the salt component is present at a concentration greater than 9 pphp the foamable mixture gels too quickly, inhibiting spreading into a board.

The quat component (c) is present at a concentration of 0.05 to 0.45 pphp, preferably 0.13 to 0.4 pphp. If present at a concentration less than 0.05 pphp the resulting foam surprisingly will not achieve a Class A rating in ASTM E-108-05 testing with an EPDM or TPO membranes at a slope of 1.27 centimeters (cm). If present at a concentration greater than 0.45 pphp the foamable mixture creams too fast to allow spreading into a board.

Catalyst component (d) is present at a concentration of zero to 0.4 parts, preferably 0.12 to 0.4 pphp. If catalyst component (d) is present at a concentration greater than 0.4 pphp the foamable mixture creams too fast to allow spreading into a board.

The molar ratio of (b) to (c) is in a range of 17:1 to 100:1. If the molar ratio is less than 17:1, so much catalyst is required to form a desirable foam that the foamable mixture creams too fast to spread into a board. If the molar ratio exceeds 100:1 the foamable mixture either gels too fast to spread into a board or will not produce a foam that can achieve a Class A rating in ASTM E-108-05 testing with an EPDM or TPO membranes at a slope of 1.27 cm.

Suitable isocyanate-containing components include any isocyanate-containing components suitable for preparing polyisocyanurate foam. Preferred isocyanate-containing components include polymeric methylene diphenyl diisocyanate polymeric (MDI) and toluene diisocyanate (TDI) and/or oligomeric forms of TDI. Polymeric MDI is particularly desirable because it has a low toxicity and low vapor pressure at room temperature. Examples of commercially available polymeric MDI include PAPI™ 580N (PAPI is a trademark of The Dow Chemical Company), PAPI™ 20, PAPI™ 27, MONDUR™ E-489 (MODNUR is a trademark of Bayer Material Science LLC LTD), MODNUR™ MR, MONDUR™ 437, RUBINATE™ HR-185 (RUBINATE is a trademark of Huntsman International LLC LTD), and LUPRANATE™ M70 (LUPRANATE is a trademark of BASF Aktiengesellshaft).

The polyol can be any polyol that is suitable for use in polyisocyanurate foam preparation. Desirably, the polyol is one or more polyester polyol, even more desirably one or more aromatic polyester polyol. Aromatic polyester polyols are particularly desirable because they offer optimal flame retardant properties by having less hydrogen atoms per molecule than aliphatic polyols and by producing a protective char when burned. Both of these features cause the aromatic polyester polyols to increase flame retardant properties of a foam relative to aliphatic polyols.

It is desirable that the polyol have an average of two to six, preferably two to five, more preferably two to four, still more preferably two hydroxy functionalities per molecule in order to produce polyisocyanurate foam having desirable properties. Polyols having a higher average hydroxy functionality per molecule will produce a more highly crosslinked polymer foam and a more rigid polymer foam. However, too much rigidity undesirably causes brittleness and friability.

The polyol component can comprise a polyol having the desired average hydroxy functionality or comprise polyols having different numbers of hydroxy functionalities but with an average number of hydroxy functionalities over all polyols in the desired range.

Polyester polyols for use in the invention can be prepared by known procedures from a polycarboxylic acid component comprising a polycarboxylic acid or acid derivative, such as an anhydride or ester of the polycarboxylic acid, and any polyol component. The polyol component advantageously comprises a glycol(s) or a glycol-containing mixture of polyols. The polyacid and/or polyol components may, of course, be used as mixtures of two or more compounds in the preparation of the polyester polyols. Particularly suitable polyester polyols for use in the foam production are aromatic polyester polyols such as those produced by Invista under the tradename TERATE™.

Polyester polyols whose acid component advantageously comprises at least about 30% by weight of phthalic acid residues are particularly useful. By phthalic acid residue is meant the group:

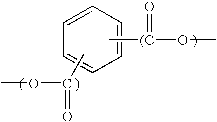

While the aromatic polyester polyols can be prepared from substantially pure reactant materials, more complex ingredients are advantageously used, such as the side-stream, waste or scrap residues from the manufacture of phthalic acid, terephthalic acid, dimethyl terephthalate, polyethylene terephthalate, and the like. Particularly suitable compositions containing phthalic acid residues for use in the invention are (a) ester-containing by-products from the manufacture of dimethyl terephthalate, (b) scrap polyalkylene terephthalates, (c) phthalic anhydride, (d) residues from the manufacture of phthalic acid or phthalic anhydride, (e) terephthalic acid, (f) residues from the manufacture of terephthalic acid, (g) isophthalic acid and (h) trimellitic anhydride, and (i) combinations thereof. These compositions may be converted by reaction with the polyols of the invention to polyester polyols through conventional transesterification or esterification procedures.

A preferred polycarboxylic acid component for use in the preparation of the aromatic polyester polyols is phthalic anhydride. This component can be replaced by phthalic acid or a phthalic anhydride bottoms composition, a phthalic anhydride crude composition, or a phthalic anhydride light ends composition, as such compositions are defined in U.S. Pat. No. 4,529,744. Aromatic polyester polyol obtained from phthalic anhydride or mixtures of phthalic anhydride and other polycarboxylic acid components include STEPANOL™ brand polyols (STEPANOL is a trademark of Stepan Chemical Company).

Other preferred materials containing phthalic acid residues are polyalkylene terephthalates, especially polyethylene terephthalate (PET), residues or scraps.

Still other preferred residues are DMT process residues, which are waste or scrap residues from the manufacture of dimethyl terephthalate (DMT). The term “DMT process residue” refers to the purged residue which is obtained during the manufacture of DMT in which p-xylene is converted through oxidation and esterification with methanol to the desired product in a reaction mixture along with a complex mixture of by-products. The desired DMT and the volatile methyl p-toluate by-product are removed from the reaction mixture by distillation leaving a residue. The DMT and methyl p-toluate are separated, the DMT is recovered and methyl p-toluate is recycled for oxidation. The residue which remains can be directly purged from the process or a portion of the residue can be recycled for oxidation and the remainder diverted from the process, or, if desired, the residue can be processed further, as, for example, by distillation, heat treatment and/or methanolysis to recover useful constituents which might otherwise be lost, prior to purging the residue from the system. The residue which is finally purged from the process, either with or without additional processing, is herein called DMT process residue.

These DMT process residues may contain DMT, substituted benzenes, polycarbomethoxy diphenyls, benzyl esters of the toluate family, dicarbomethoxy fluorenone, carbomethoxy benzocoumarins and carbomethoxy polyphenols. Invista sells DMT process residues under the tradename TERATE™.

Another suitable polyol component is a glycol. The glycols may contain heteroatoms (for example, thiodiglycol) or may be composed solely of carbon, hydrogen, and oxygen. They are advantageously simple glycols of the general formula CₙH₂ₙ(OH)₂ or polyglycols distinguished by intervening ether linkages in the hydrocarbon chain, as represented by the general formula CₙH₂ₙOₓ(OH)₂. In a preferred embodiment of the invention, the glycol is a low molecular weight aliphatic diol of the generic formula:

HO—R—OH

wherein R is a divalent radical selected from the group consisting of:

(a) alkylene radicals each containing from 2 through 6 carbon atoms, and

(b) radicals of the formula:

—(R¹O)ₘ—R¹—
wherein R¹ is an alkylene radical containing from 2 through 6 carbon atoms, and m is an integer of from 1 through 4, and

(c) mixtures thereof.

Examples of suitable polyhydric alcohols include: ethylene glycol; propylene glycol-(1,2) and -(1,3); butylene glycol-(1,4) and -(2,3); hexane diol-(1,6); octane diol-(1,8); neopentyl glycol; 1,4-bishydroxymethyl cyclohexane; 2-methyl-1,3-propane diol; glycerin; trimethylolpropane; trimethylolethane; hexane triol-(1,2,6); butane triol-(1,2,4); pentaerythritol; quinol; mannitol; sorbitol; methyl glucoside; diethylene glycol; triethylene glycol; tetraethylene glycol and higher polyethylene glycols; dipropylene glycol and higher polypropylene glycols as well as dibutylene glycol and higher polybutylene glycols. Especially suitable polyols are alkylene glycols and oxyalkylene glycols, such as ethylene glycol, diethylene glycol, dipropylene glycol, triethylene glycol, tripropylene glycol, tetraethylene glycol, tetrapropylene glycol, trimethylene glycol and tetramethylene glycol, and 1,4-cyclohexanedimethanol (1,4-bis-hydroxymethylcyclohexane).

The term “polyester polyol” as used in this specification and claims includes any minor amounts of unreacted polyol remaining after the preparation of the polyester polyol and/or unesterified polyol (for example, glycol) added after the preparation. The polyester polyol can advantageously include up to about 40 weight percent free glycol.

The polyester polyols advantageously have an average functionality of about 1.8 to 8, preferably about 1.8 to 5, and more preferably about 2 to 2.5. Their hydroxyl number values generally fall within a range of about 15 to 750, preferably about 30 to 550, and more preferably about 100 to 550, and their free glycol content generally is from about 0 to 40, preferably from 2 to 30, and more preferably from 2 to 15, weight percent of the total polyester polyol component.

Examples of suitable polyester polyols are those derived from PET scrap and available under the designation TEROL™ 235 (TEROL is a trademark of Oxid Limited Partnership), CHARDOL 170, 336A, 560, 570, 571 and 572 from Chardonol and FREOL™ 30-2150 (FEOL is a trademark of Japan Energy Corporation). Examples of suitable DMT derived polyester polyols are TERATE™ 202, 203, 204, 214, 254, 254A and 2541 polyols, which are (TERATE is a trademark of Invista North America). Phthalic anhydride derived-polyester polyols are commercially available under the designation PLURACOL polyol 9118 (PLURACOL is a trademark of BASF Corporation), and STEPANOL™ PS-2002, PS-2352, PS-2402, PS-2502A, PS-2502, PS-2522, PS-2852, PS-2852E, PS-2552, and PS-3152 (STEPANOL is a trademark of Stepan Company). Especially useful polyester polyols are TEROL 235, STEPANOL PS-1922 and TERATE 3512A.

The polyols which can be employed in combination with polyester polyols in the preparation of the polyisocyanurate foam compositions of the invention include monomeric polyols and polyether polyols. Suitable polyether polyols are the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (for example, 4-8).

Desirably, the polyol component is one or more polyol having an aggregate molecular weight in the range of 200-1200, more preferably 300-900, and most preferably 600-650.

In a desirable embodiment, the ratio of isocyanate-containing component and hydroxy-containing component is sufficient to produce an isocyanate index for the reactive mixture in a range of 200-600, preferably 250-400. A reactive mixture of this composition is a further aspect of the present invention.

The foamable mixture further comprises a blowing agent. Any suitable hydrogen atom-containing blowing agent is suitable for the expandable reaction mixture of the present invention. Suitable blowing agents include hydrocarbons, partially halogenated hydrocarbons, ethers, and esters, hydrocarbons, esters, ethers, and the like. Among the usable hydrogen-containing halocarbons are the HCFC's such as 1,1-dichloro-1-fluoroethane (HCFC-141b), 1,1-dichloro-2,2,2-trifluoroethane (HCFC-123), monochlorodifluoromethane (HCFC-22), 1-chloro-1,1-difluoroethane (HCFC-142b), 1,1-difluoroethane (HCFC-152a), and 1,1,1,2-tetrafluoroethane (HFC-134a). The blowing agent can be halogen-free.

A wide variety of co-blowing agent(s) can be employed in conjunction with the hydrogen-containing halocarbons in preparing the foam compositions of the invention. Water, air, nitrogen, carbon dioxide, readily volatile organic substances and/or compounds which decompose to liberate gases (for example, azo compounds) may be used. Typically, these co-blowing agents are liquids having a boiling point between minus 50. degree. C. and plus 100° C., and preferably between −50° C. and +50° C.

The blowing agents are desirably employed in an amount sufficient to give the resultant foam the desired bulk density which is generally between 0.5 and 10, preferably between 1 and 5, and most preferably between 1.5 and 2.5, pounds per cubic foot. The blowing agents generally comprise from 1 to 30, and preferably comprise from 5 to 20 weight percent of the composition. When a blowing agent has a boiling point at or below ambient, it is maintained under pressure until mixed with the other components. Alternatively, it can be maintained at subambient temperatures until mixed with the other components.

It is particularly desirable to include a hydrocarbon blowing agent, particularly one or more isomer of pentane as a blowing agent. It is still more desirable to include with the hydrocarbon blowing agent between 0.2 and 1.6 wt %, preferably between 0.4 and 1.0 wt % water based on the total weight of non-water hydroxy-containing components in order to achieve small uniform cells and reduce flammability while maintaining dimensional stability.

The method may also include adding at any point additional components including blowing agents, surfactants, flame retardants, fillers, viscosity reducers, heat stabilizers and ultraviolet (UV) stabilizers to produce a mixture containing those additional components.

Suitable surfactants include silicone/ethylene oxide/propylene oxide copolymers, polydimethylsiloxane-polyoxyalkylene block copolymers available from Ele-Pelron Corporation under the tradename PELSIL™9736, from the Dow Corning Corporation under the trade names “DC-193” and “DC-5315”, and from Goldschmidt Chemical Corporation under the tradenames “B-8408” and “B-8407”. Other suitable surfactants are those described in U.S. Pat. Nos. 4,365,024 and 4,529,745. The Dow Chemical Company offers a suitable butylene and ethylene oxide block copolymer surfactant under the tradename VORASURF™ 504.

Mixtures of surfactants can provide cost savings such as with PELSIL 8736 and PSI-211M, which is a heavy aromatic hydrocarbon. SPI-211M is desirably present at a concentration of 25-50 wt % based on total surfactant weight.

Generally, the surfactant comprises from about 0.05 to 10, and preferably from 0.1 to 6, weight percent of the foam-forming composition. Other exemplary silicone surfactants include DABCO™-193 and DABCO™-197 (DABCO is a trademark of Air Products and Chemicals, Inc.) Surfactants are typically present at a concentration up to about four wt % based on hydroxy-containing component weight.

Suitable flame retardants include phosphate and halogenated compounds. Examples of suitable flame retardants include ANTIBLAZE™ 80 and SAYTEX™ RB7940F (ANTIBLAZE and SAYTEX are trademarks of Albemarle Corporation. Flame retardants are typically present at a concentration of up to forty wt % based on hydroxy-containing component weight.

Exemplary fillers include glass fibers, carbon black, graphite, and other pigments.

Exemplary viscosity reducers include triethylphosphate, trichloropropylphosphate, trichloroethylphosphate, dioctylphthalate, diisooctylphthalate, dibutylphthalate, diisobutylphthalate, dicaprylphthalate, diisodecylphthalate, tricresylphosphate, trioctylphosphate, diisooctyladipate and diisodecyladipate. Commercially available viscosity reducers include VIPLEX™ 5, 885 and 525 (VIPLEX is a trademark of Crowley Chemical Company). Viscosity reducers are typically present at a concentration up to forty wt %, preferably in a range from two to twenty wt %, more preferably at a concentration of about fifteen wt % based on total weight of hydroxy-containing component.

### EXAMPLES

The following examples serve to further illuminate embodiments of the present invention.

Prepare a foamable mixture by feeding four independent streams into a high pressure impingement mixer at a pressure of 1200 pounds per square inch (8.3 mega pascals (MPa) to form a foamable reactive composition. One stream is a polymeric methylene diisocyanate (PAPI™ 580N from The Dow Chemical Company; PAPI is a trademark of The Dow Chemical Company). One stream is a catalyst stream (See Table 1). One stream is a polyol-containing stream (see Table 2). One stream is a blowing agent stream. The blowing agent stream is a blend of 80 wt % cyclopentane and 20 wt % isopentane (for example, EXXSOL™ 2000; EXXSOL is a trademark of Exxon Mobile). The streams blend in an impingement mixer to form a foamable mixture. Table 3 identifies the foamable mixture for each example.

In Example 1, the salt component is present at a concentration of 4 pphp, the quat component at 0.2 pphp and the amine at 0.07 pphp. The molar ratio of salt component to quat is 23.5:1

For Comparative Example A, the salt component is present at a concentration of 2.7 pphp, the quat component at 0 pphp and the amine at 0.045 pphp. The molar ratio of salt component to quat is undefined since there is no quat.

TABLE 1
Catalyst Composition

| | | Weight Percent of Active | |
|---|---|---|---|
| | | Ingredient based on | |
| | Active | Total Catalyst Composition | |
| | Ingredient | | Comparative |
| Component | (wt %) | Example 1 | Example A |
| 2-hydroxypropyl trimethyl ammonium | 100 | 2.6 | 0 |
| formate (DABCO TMR-2 ™)¹ | | | |
| Potassium 2-ethylhexanoate in | 70 | 23.9 | 24.5 |
| diethylene glycol (Pel-Cat 9540A) | | | |
| Potassium acetate in diethylene | 70 | 23.9 | 24.5 |
| glycol | | | |
| Triethylene diamine in | 33 | 0.8 | 0.83 |
| polypropylene glycol (DABCO | | | |
| 33LV ™)¹ | | | |
| diethylene glycol (solvent from | 100 | 48.9 | 50.2 |
| potassium salts and diamine) | | | |

¹DABCO 33LV and DABCO TMR2 are trademarks of Air Products and Chemicals, Inc.

TABLE 2
Polyol-Containing Stream

| | Weight Percent based | |
|---|---|---|
| | on Total Polyol- | |
| | Containing Stream | |
| | | Comparative |
| Component | Example 1 | Example A |
| Aromatic polyester polyol (TERATE ™ | 91.4 | 93.8 |
| 3512A)¹ | | |
| Flame Retardant (SAYTEX ™ RB 7940)² | 3.4 | 3.5 |
| Silicone Surfactant (PELSIL ™ 9736) | 4.4 | 0 |
| Ethyleneoxide-butylene-oxide | 0 | 2.3 |
| surfactant (VORASURF ™ 504)³ | | |
| Water | 0.8 | 0.4 |

¹TERATE is a trademark of Invista North America
²SAYTEX is a trademark of Albemarle Corporation
³VORASURF is a trademark of The Dow Chemical Company

TABLE 3
Reactive Foamable Composition

Weight Percent based
on Total Reactive
Foamable Composition

| | | Comparative |
|---|---|---|
| Component Stream | Example 1 | Example A |
| Polymeric methylene diisocyanate | 63.2 | 56.7 |
| Catalyst Stream | 2.4 | 1.9 |
| Polyol-Containing Stream | 28.8 | 34.7 |
| Blowing Agent Stream | 5.6 | 6.7 |
| Isocyanate Index | 292 | 243 |

From the high pressure impingement mixer, deposit the foamable mixture onto a bottom facer (in this case, a glass fiber reinforced organic felt (ULTRAFACE™ facer from GAF, ULTRAFACE is a trademark of GAF). Dispose a top facer identical to the bottom facer onto the foamable reactive composition while conveying through an oven at a temperature of 60° C.-80° C. for 45-60 seconds and allowing the foamble reactive composition to expand to a thickness of 5.08 centimeters (2 inches) against a platen. Cream time for Example 1 is 4 seconds, Comparative Example A is 6 seconds. Gel Time for Example 1 is 13 seconds, Comparative Example A is 16 seconds. The density of Example 1 is 30.6 kilograms per cubic meter (kg/m³) (1.91 pounds per cubic foot (pcf)), Comparative Example A is 28.4 kg/m³ (1.77 pcf).

Test the resulting structural laminates (Example 1 and Comparative Example A) according to Underwriters' Laboratory (UL) test method 790. For the testing, mechanically fasten a fiber reinforced EPDM membrane to the top of the laminate. Example 1 passes UL790 testing while Comparative Example A does not pass ULS790 testing.

The polyisocyanurate foam of Example 1 further has a compressive strength of 145 kilo pascals (21 pounds per square inch) according to ASTM method D1621. As a result, Example 1 achieves a grade 2 designation according to ASTM method C-1289 compressive strength testing. In contrast, Comparative Example A demonstrates a compressive strength of 117 kilo pascals (17 pounds per square inch) according to ASTM method D1621, which warrants only a grade 1 designation according to ASTM method C-1289 compressive strength testing.

Comparative Example A illustrates a foamable mixture and process that are outside the scope of the present invention. Notably, a structural laminate prepared in accordance with Comparative Example A does not pass UL790 testing.

1. A foamable mixture comprising: (a) 100 parts by weight of one or more polyol; (b) 2 to 9 parts by weight of one or more salt selected from potassium carboxylate and sodium carboxylate salts; (c) 0.05 to 0.45 parts by weight of one or more quaternary amine; (d) zero to 0.4 parts by weight of one or more catalyst compound selected from a group consisting of secondary amines, tertiary amines, tin catalysts and iron catalysts; (e) optionally, a solvent; (f) an isocyanate-containing compound; and (g) a blowing agent; wherein, the molar ratio of (b) to (c) is in a range of 17:1 and 100:1.

2. The foamable mixture of claim 1, wherein (c) is one or more alkyl carboxylate quaternary amine.

3. The foamable mixture of claim 1, wherein component (b) comprises one or more potassium carboxylate.

4. The foamable mixture of claim 1, wherein (b) is present at 2.4-7 weight parts; (c) is present at 0.13 to 0.4 weight parts; and (d) is present at 0.12 to 0.4 weight parts.

5. The foamable mixture of claim 1, wherein component (b) is one or more potassium carboxylate, component (c) is one or more alkyl carboxylate quaternary amine, component (d) is one or more tertiary amine and is present at a concentration of 0.12 to 0.4 weight parts.

6. The foamable mixture of claim 1, wherein the polyol is a polyester polyol.

7. The foamable mixture of claim 6, wherein the amount of isocyanate containing compound(s) and polyester polyol is such that the mixture has an isocyanate index in a range of 200-600.

8. The foamable mixture of claim 1, wherein the blowing agent is halogen-free.

9. The foamable mixture of claim 9, further comprising water at a concentration of 0.2 to 3 weight parts.

10. A method for preparing a laminated polyisocyanurate foam comprising: (i) disposing the foamable mixture of claim 1 onto a first facing sheet; (ii) heating the foamable mixture; and (iii) allowing the foamable composition to expand into a polyisocyanurate foam.

11. The method of claim 10, wherein the foamable mixture is continuously disposed onto the first facing sheet while the facing sheet is being conveyed.

12. The method of claim 10, further comprising disposing a second facing sheet onto the foamable mixture such that the foamable mixture is between the two facing sheets.

13. The method of claim 10, wherein the amount of isocyanate containing compound(s) and polyol is such that the mixture has an isocyanate index in a range of 200-600.

14. The method of claim 10, wherein the foamable mixture further comprises water at a concentration of 0.2 to three percent by weight based on component total weight of polyol in the mixture.

15. The method of claim 10, wherein component (b) is one or more potassium carboxylate component, (c) is an alkyl carboxylate quaternary amine, component (d) is one or more tertiary amine and is present at a concentration in a range of 0.12 to 0.4 weight parts.
